(19) United States
(12) Patent Application Publication
(10) Pub. No.: US 2016/0019504 A1
(43) Pub. Date: Jan. 21, 2016

(54) SUPPLY CHAIN MANAGEMENT TOOL TO PROMOTE A UNIFORM BUSINESS ECOSYSTEM

(71) Applicant: MasterCard International Incorporated, Purchase, NY (US)

(72) Inventor: DEBASHIS GHOSH, Charlotte, NC (US)

(73) Assignee: MasterCard International Incorporated, Purchase, NY (US)

(21) Appl. No.: 14/336,925

(22) Filed: Jul. 21, 2014

(51) Int. Cl. G06Q 10/10; G06Q 10/06

(52) U.S. Cl. CPC G06Q 10/103; G06Q 10/0633

(57) ABSTRACT

Systems and methods are provided for understanding a business ecosystem, e.g., technology asset makeup, of a company. Arising from this understanding, intelligent recommendations can be provided to, e.g., supply chain management and other personnel in the company, regarding the use and/or implementation of new or additional technology assets in order to facilitate a uniform business ecosystem.

### TECHNICAL FIELD

The present disclosure is generally related to supply chain management. More particularly, the present disclosure is directed to systems and methods for promoting uniformity amongst technology assets in a business ecosystem.

### BACKGROUND

A supply chain can refer to any system or group of entities, activities, information, resources, etc. involved in the delivery of products or services from a supplier to a customer. Supply chain activities can involve some transformation of raw materials, data, etc. into a finished product or service that can ultimately be delivered to or otherwise provided to an end customer. Supply chain entities, information, resources, etc. interact/operate to facilitate the supply chain activities. Supply chains can exist within a single business entity or across business entities within, e.g., a particular product or service industry.

Supply chain management can refer to the integration and management of the aforementioned aspects of a supply chain. That is, supply chain management can be the strategic and systematic cooperation between entities, resources, etc. across a business, for example, to achieve efficient and productive operation(s) throughout the supply chain.

### SUMMARY

In accordance with one embodiment, a method comprises receiving a request for a technology asset recommendation regarding a company's business ecosystem. The method additionally includes analyzing existing relationships between business units of the company and one or more technology assets associated with each of the business units. Further still, the method comprises providing the technology asset recommendation based on a technology asset vendor compatible with the existing relationships between the business units and the one or more technology assets associated with each of the business units.

In accordance with another embodiment, a non-transitory computer-readable medium has computer executable program code embodied thereon. The computer executable program code is configured to cause a computer system to receive a request for a technology asset recommendation regarding a company's business ecosystem. Additionally, the computer executable program code is configured to cause the computer system to access a database representative of a mapping of the relationships between the business units and the one or more technology assets associated with each of the business units. Further still, the computer executable program code is configured to cause the computer system to provide the technology asset recommendation based on the mapping of the relationships, the technology asset recommendation comprising a compatible technology asset vendor.

In accordance with yet another embodiment, a supply chain management system comprises a plurality of existing technology assets. The supply chain management system also comprises a relational database in which business units are associated with one or more of the plurality of existing technology assets utilized in accomplishing one or more functions of each of the business units. Moreover, a computing device hosting a business ecosystem application is configured to access the relational database, and based on the associations, determine a technology asset vendor to provide a to-be-implemented technology asset compatible with at least one of the plurality of existing technology assets.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates an example payment card transaction processing system.

FIG. 2 illustrates an example data warehouse system.

FIG. 3 illustrates an example business intelligence platform.

FIG. 4 illustrates an example mapping of technology assets and business units.

FIG. 5 illustrates an example screenshot of a business ecosystem tool application.

FIG. 6 is a flow chart illustrating example processes performed for providing a technology asset recommendation in accordance with various embodiments.

FIG. 7 illustrates an example computing module that may be used in implementing features of various embodiments.

The drawings are described in greater detail in the description and examples below.

### DETAILED DESCRIPTION

The details of some example embodiments of the methods and systems of the present disclosure are set forth in the description below. Other features, objects, and advantages of the disclosure will be apparent upon examination of the following description, drawings, examples and claims. It is intended that all such additional systems, methods, features, and advantages be included within this description, be within the scope of the present disclosure, and be protected by the accompanying claims.

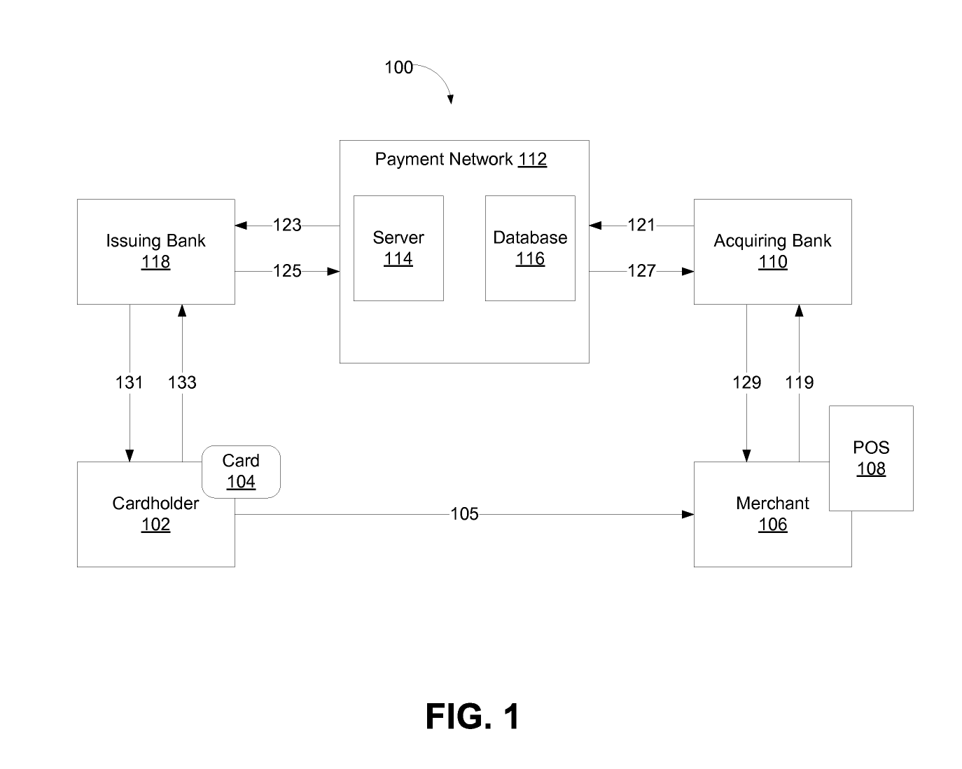

One example of an industry in which supply chain management may be utilized is in the payment transaction processing industry. Transaction processing of card-based payments can include both an authorization side and a clearance side. The authorization side may involve the process of confirming that a cardholder has a sufficient line of credit to cover a proposed payment. The clearance side of the transaction may involve the process of moving funds from an issuing bank to an acquiring merchant bank. FIG. 1 depicts an example payment card transaction processing system 100 showing both the authorization side and the clearance side of card-based payments.

In a typical card-based payment transaction system, a cardholder 102 presents a credit/debit/prepaid card 104 to a merchant 106 for the purchase of goods and/or services. This transaction is indicated by arrow 105. A “card” 104, as used herein, can refer to a conventional magnetic-stripe credit, debit card, or similar proximity payment device (utilized on its own or incorporated into another device such as a mobile telephone, personal digital assistant (PDA), etc.) having near field communications (NFC) capabilities, such as a radio frequency identification (RFID) chip implemented therein. A “card” can further refer to virtual or limited use account numbers and electronic wallets.

It is understood that prior to the occurrence of such a transaction, cardholder 102 was issued card 104 by an issuing bank 118. Moreover, it will be understood that merchant 106 has established a relationship with an acquiring bank 110, thereby allowing merchant 106 to receive payment cards as payment for goods and/or services. That is, merchant banks and issuing banks may participate in various payment networks, including payment network 112. One such payment network is the one operated by MasterCard International Incorporated, the assignee of the present disclosure.

After presentation of payment card 104 to merchant 106 by cardholder 102, merchant 106 may send an authorization request (indicated by arrow 119) to acquiring bank 110 via a point-of sale (POS) terminal 108 located at or otherwise controlled by merchant 106. In turn, acquiring bank 110 communicates with payment network 112 (indicated by arrow 121), and payment network 112 communicates with issuing bank 118 (indicated by arrow 123) to determine whether issuing bank 118 will approve the transaction 105 that cardholder 102 is attempting to make. An approval or disapproval of the authorization request is thereafter transmitted back to merchant 106 (indicated by arrows 125, 127 and 129). Merchant 106 may then either complete or cancel transaction 105 based upon the response to the authorization request.

If transaction 105 is approved, the transaction amount will be sent from issuing bank 118 through payment network 112 to acquiring bank 110. The transaction amount, minus certain fees, will thereafter be deposited within a bank account belonging to merchant 106. Issuing bank 118 may then bill cardholder 102 (indicated by arrow 131) for the transaction amount by sending a periodic cardholder statement. Cardholder 102 follows by submission of payment(s) (as indicated by arrow 133) to issuing bank 118. This submission of payment(s) (as indicated by arrow 133) by cardholder 102 may be automated (e.g., in the case of debit transactions), may be initiated by cardholder 102 for the exact amount matching the total cost of all purchases during the statement period (e.g., charge cards or credit balances paid in full), and/or may be submitted (in part or in whole) over a period of time that thereby reflects the costs of the purchases plus any financing charges agreed upon beforehand between cardholder 102 and issuing bank 118 (e.g., revolving credit balances).

Payment network 112 preferably includes at least one server 114 and at least one database 116. Server 114 may include various computing devices such as a mainframe, personal computer (PC), laptop, workstation or the like. Server 114 can include a processing device and be configured to implement an authorization and clearance process, which can be stored in computer storage associated with server 114. Database 116 may include computer readable medium storage technologies such as a floppy drive, hard drive, tape drive, flash drive, optical drive, read-only memory (ROM), random access memory (RAM), and/or the like. Server 114 and database 116 may be controlled by software/hardware and may store data to allow it to operate in accordance with aspects of the present disclosure.

POS terminal 108 is in data communication, directly or indirectly, and at least from time to time, with, e.g., an acquirer host computer (not shown) that is part of payment network 112 and is operated for or on behalf of acquiring bank 110, which handles payment card transactions for merchant 106. Server 114 may be operated by or on behalf of the payment network 112, and may provide central switching and message routing functions among the member financial institutions of the payment card association. Issuing bank 118 also preferably makes use of an issuer host computer (not shown), and an access point (not shown) via which the issuer host computer exchanges data messages with server 114. It should be noted that in practice, payment card transaction processing system 100 may involve a large number of cardholders, POS terminals, acquirer host computers, issuer host computers, and access points. In general, the acquirer host computer can receive authorization requests from POS terminals, forward the authorization requests through payment network 112, receive authorization responses, and relay the authorization responses to POS terminal 108. Moreover, the issuer host computer may in general, receive authorization requests from server 114 and transmit authorization responses back to server 114 with respect to the authorization requests.

The use of payment cards for a broad spectrum of cashless transactions has become ubiquitous in the current economy, accounting for hundreds of billions of dollars in transactions during a single year. For example, MasterCard processes upwards of 160 million transactions per hour in over 230 countries. It should be appreciated that the amount of information and resources (e.g., technology assets) involved in performing and coordinating payment transactions, at any point in payment card transaction processing system 100 is enormous.

A payment network may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include gift cards, personalized gift cards, payment cards, letters of credit, checks, financial accounts, etc. Accordingly, a payment network relies on variety of resources, such as technology assets in the form of various hardware and/or software platforms, databases, internal networks, etc. For example, databases may be used to store and maintain profiles and/or accounting information associated with the aforementioned payment cards, letters of credit, financial accounts, etc.

Above and beyond the actual processing of transaction payments, information gathered from the above transactions may be stored and/or integrated from one or more disparate sources, for the purposes of, e.g., performing statistical analysis on current and historical data, as well as leveraging such data for marketing, advertising, monetization of information, etc. Hence, one example of a business function of a company may be data warehousing.

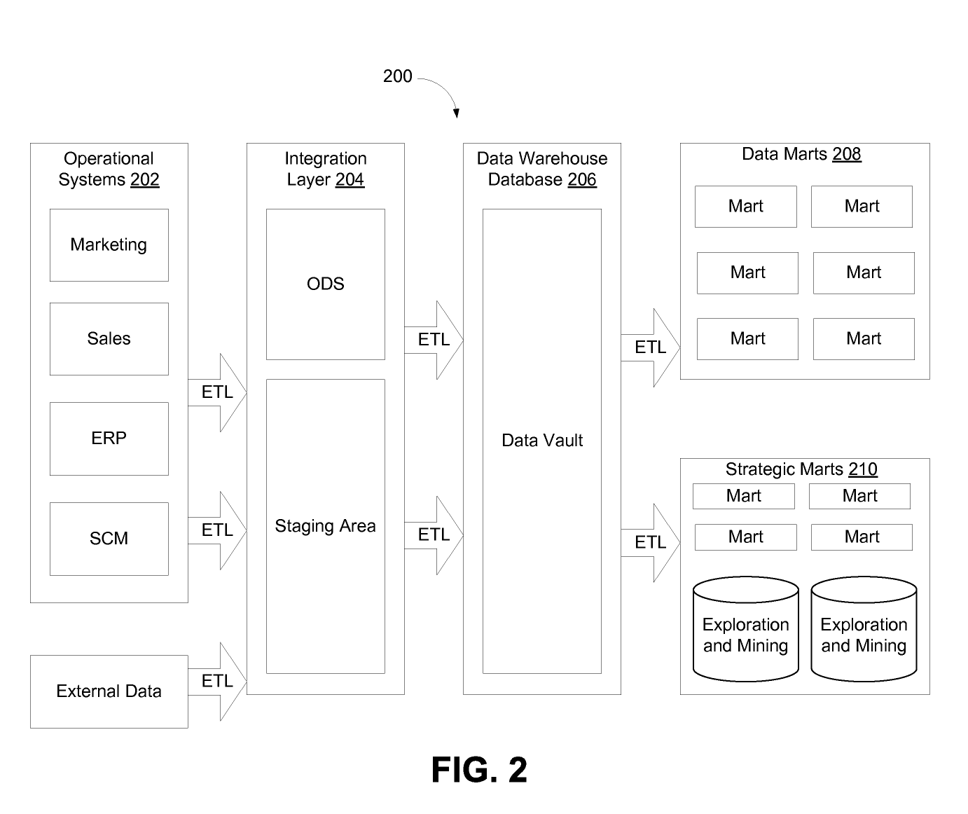

FIG. 2 illustrates an example data warehouse system 200. Data may be uploaded from one or more operational systems 202 that can include, but are not limited to, a marketing system(s), a sales system(s), an enterprise resource planning (ERP) system(s), a supply chain management (SCM) system(s). The uploaded data may then pass through an operational data store (ODS) in integration layer 204 to be further processed/undergo additional operations.

That is, an extract-transform-load (ETL)-based data warehouse may rely on staging, integration, and access layers in which the key functions of data warehouse system 200 may be maintained. A staging area/database may store raw data extracted from each of the disparate source data systems described above with reference to operational systems 202. An integration layer may integrate the disparate (raw) data sets by transforming the raw data from the staging area and storing this transformed data in an ODS database. The integrated/transformed data may then be moved to data warehouse database 206, where the data can be arranged into hierarchical groups. It should be noted that another type of data warehouse, an integrated data source-based data warehouse, where data is obtained from integrated data source systems, rather than disparate data source systems, may not require ETL staging databases as the integrated data source systems can be considered to be part of the ODS. Accordingly such data need not be transformed.

Data marts 208 and strategic marts 210 can refer to small data warehouses focused on, e.g., specific areas of interest, and may be subdivided into individual marts and/or additional databases for exploration/mining of the data for improved performance and ease of use within that area of interest. Alternatively, a company may create one or more data marts that can be used as building blocks a larger and more complex enterprise data warehouse.

Moreover, the concept of data warehousing may further include or may be included in the concept of business intelligence. Business intelligence can refer to theories, methodologies, architectures, and/or technologies that transform raw data into meaningful and useful information for business purposes. In conjunction with data warehousing, business intelligence can include, for example, the following: multidimensional aggregation and allocation; denormalization, tagging and standardization; real-time reporting with analytical alerts; interfacing with unstructured data sources; statistical inference and probabilistic simulation operations; key performance indicator optimization; version control and process management; and open item management. Thus, business intelligence technologies can be utilized to provide historical, current, and/or futuristic/predictive views of the operation of a company, and may include, e.g., reporting, online analytical processing, analytics, data mining, process mining, complex event processing, business performance management, benchmarking, text mining, predictive analytics, and prescriptive analytics.

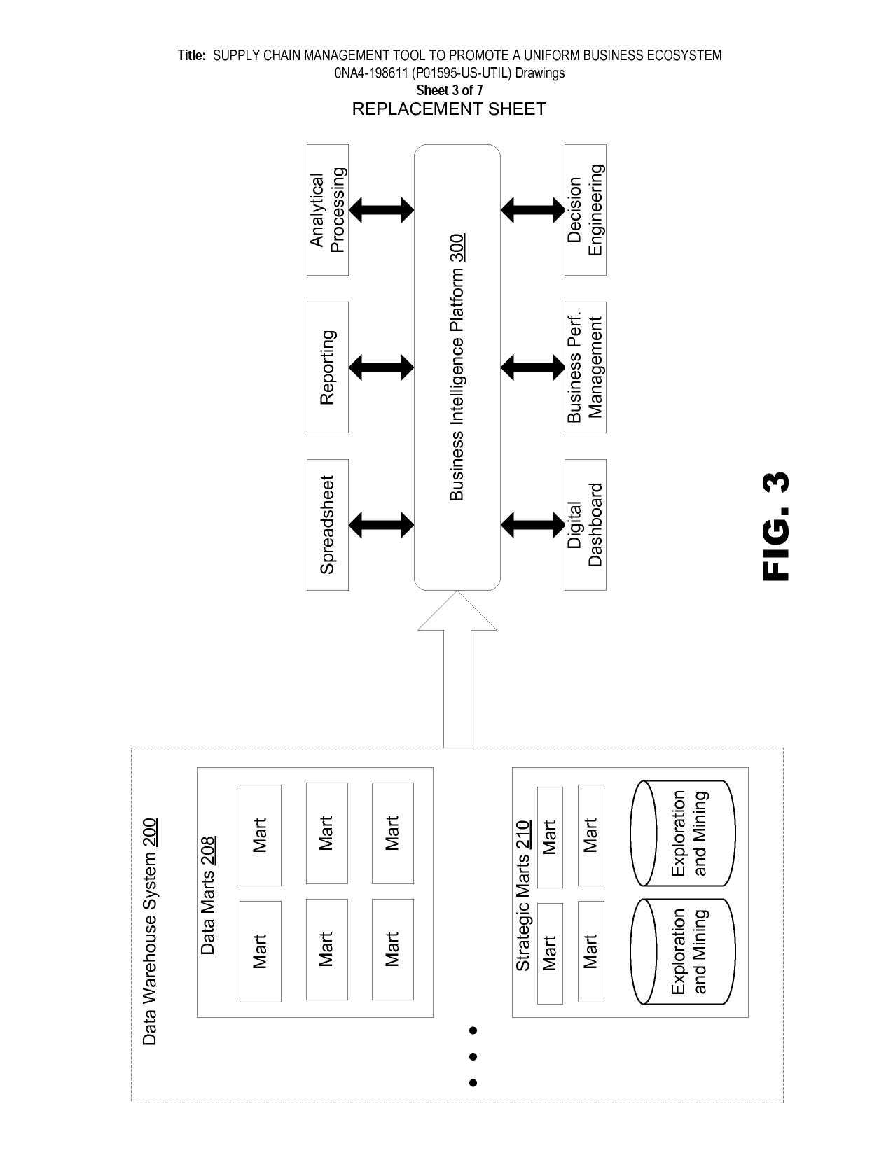

FIG. 3 illustrates an example business intelligence platform 300 that operates in conjunction with data warehouse system 200 as described above. Business intelligence platform 300 can refer to, e.g., a computing platform on which business intelligence tools can be developed and/or executed. Business intelligence tools, reflective of the aforementioned business intelligence technologies, can refer to a type of application software designed to retrieve, analyze and report data for achieving such business intelligence. Business intelligence tools generally read data that has been previously stored, e.g., in a data warehouse or data mart. Examples of business intelligence tools can include, but are not limited to, the following: spreadsheets; reporting and querying software, online analytical processing, digital dashboards, business performance management, decision engineering etc.

A primary objective of supply chain management is to fulfill customer demands through the most efficient use of resources, which, as described above, can include technology assets including data warehouses and business intelligence platforms. It should be noted that other types/forms of business functions and/or resources can be the object of supply chain management optimization as described in accordance with various embodiments herein, for example application performance management technology, continuous controls monitoring, enterprise content management, data center services, etc.

A common shortcoming in many companies is the use of disparate technologies for accomplishing their data warehousing and business intelligence platform needs. For example, companies or entities such as a payment transaction network, may rely on a plethora of different data warehouses and/or business intelligence platforms to support different business functions and/or business units. This non-uniformity in the supply chain is even more problematic given the increasing globalization of companies, where the disparities can be exacerbated between departments or corporate subdivisions located in different countries. Thus, the logistics of ensuring that data can be transmitted and properly recognized and/or utilized amongst all of the technologies becomes increasingly complex due to the need for scripts, data models, etc. to overcome issues such as data incompatibility.

Accordingly, various embodiments provide systems and methods for understanding the business “ecosystem” (in this instance, technology asset makeup) of a company. Arising from this understanding, intelligent recommendations can be provided to, e.g., supply chain management and other personnel in a company, regarding the use and/or implementation of technology assets in order to facilitate a uniform business ecosystem. Such uniformity may be achieved by incorporating technology assets by a single or the least amount of different vendors possible in order to reduce the instances of, e.g., necessary data, software, or protocol translation/conversion due to incompatibilities. Uniformity can also be achieved by implementing technology assets with a preferred data, software, and/or hardware compatibility (i.e., requiring the least amount of extraneous resources to achieve compatibility). Moreover, the use and/or purchase of technology assets from vendors can be rationalized. Further still, existing technology assets can be analyzed and validated as to their usefulness to a company, allowing outdated or poor-performing technology assets to be replaced or phased out in light of more innovative, more efficient, faster, or otherwise more appropriate technology assets. Thus, early detection of issues in the supply chain can prevent or head off unwanted vendor or technology lock-in or entrenchment.

In the context of data warehousing, a company may rely on data warehousing technology, such as relational database management systems for creating, updating, and/or administering a relational database. Relational database management systems can be provided by a variety of vendors, such as the IBM® Corporation, which provides the DB2 relational database management system (RDBMS), the Oracle® Corporation, which provides the Oracle Database RDBMS, and the Teradata® Corporation, which provides the Teradata Database DBMS. In the context of business intelligence, a variety of platforms are available for use, e.g., Microsoft BI from the Microsoft® Corporation, Tableau Server from Tableau® Software, Cognos Business Intelligence from the IBM® Corporation, and Analytics Platform from MicroStrategy®, Inc.

If, for example, a particular business unit or department is utilizing the Oracle® Database for data warehousing purposes, it should be indicated to personnel requesting a business intelligence tool, such as an analytical processing tool, that the Tool for Oracle Application Developers (TOAD) Business Intelligence platform should be used to develop that business intelligence tool. Allowing personnel to implement a business intelligence tool developed on a disparate business intelligence platform such as Analytics Platform would likely be detrimental due to, e.g., additional measures needed for making data compatible between the business intelligence platform and data warehouse provided by different vendors. Thus, awareness of the technology assets or other aspects of a company's business ecosystem could prevent such compatibility issues.

To create awareness of a company's business ecosystem, various embodiments may create a database, e.g., a relational database that maps the company's business units and functionalities to the technology assets that support those business units and functionalities. To create such a database, information regarding any and all possible vendors as well as their associated products can be compiled. Such information can be gleaned by accessing and analyzing, e.g., Form 10-K and/or Form 10-Q reports, to obtain relevant information regarding vendors, relationships, competitors, etc. It should be noted that information such as risk factors, legal proceedings, financial statements, etc. can also be determined from the Form 10-K and/or Form 10-Q reports, to be used as additional factors in validating or rationalizing use of technology assets.

Additionally still, evaluative information, such as can be obtained from e.g., Garner® Magic Quadrants reports (which provides a visualization tool for monitoring and evaluating the progress and positions of companies in specific, technology-based markets). Hence, the evaluative information can be overlaid or otherwise combined with the aforementioned vendor information to further benchmark or rank vendors as appropriate in the context of supply chain management described herein.

Once the above-mentioned information is gathered and stored, e.g., in a relational database, one or more applications or tools can be developed to allow supply chain management or other personnel to obtain desired information regarding the vendors, their technology, interoperability, etc. Moreover, and as alluded to previously, the above-mentioned information can be mapped to the company's business units and functionalities so that the company's business ecosystem and be viewed and/or queries can be made regarding the business ecosystem for supply chain management purposes.

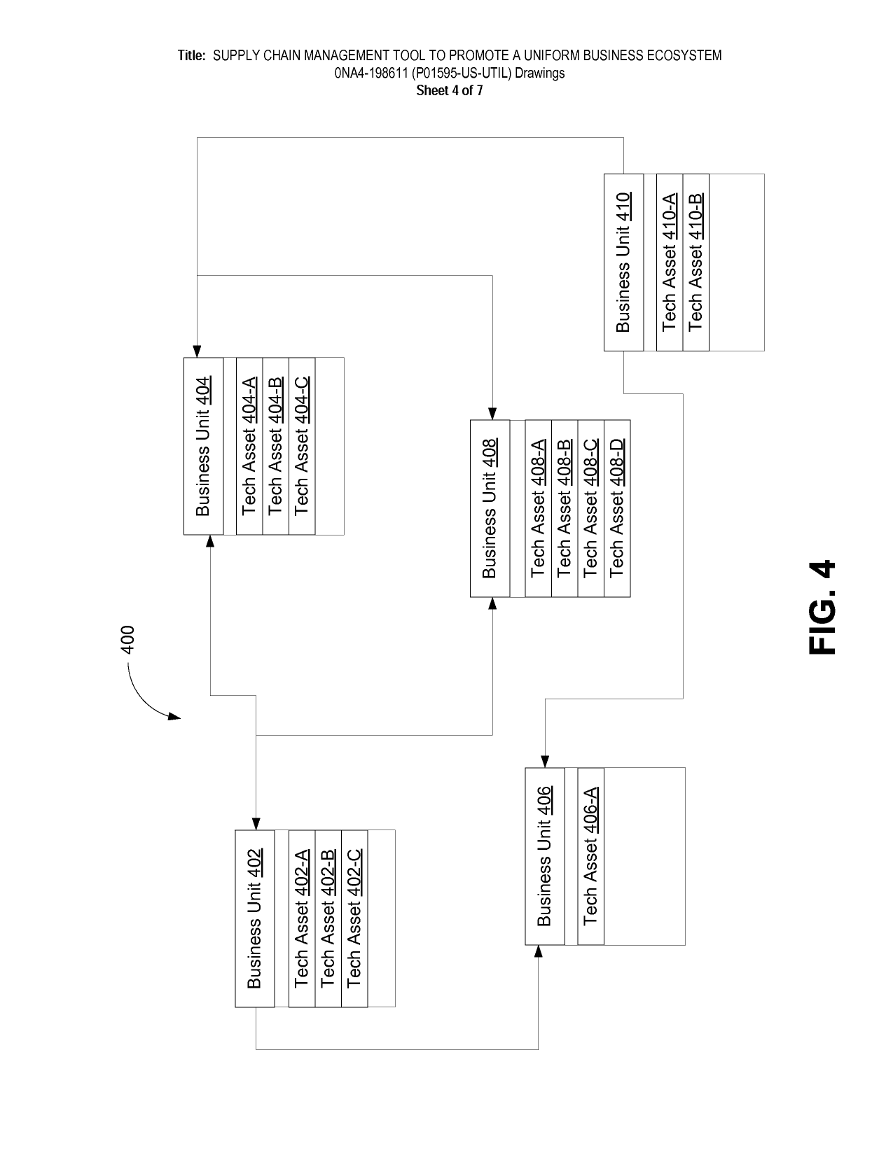

FIG. 4 illustrates an example map 400 of a company's business ecosystem to technology assets. This map can be utilized as a back-end aspect upon which queries and/or recommendations (as will be discussed in detail below) can be based. However, users such as supply chain managers may also be presented with a visual representation of such a map, again, in order to provide a view of a company's business ecosystem and technology assets. Map 400 includes a plurality of business units 402-410. Each of business units 402-410 may have associated therewith, one or more technology assets such as data warehouses, business intelligence platforms and/or tools, etc. Map 400 illustrates the various relationships between business units 402-410. It should be noted that the granularity or detail with which such relationships is maintained in the relational database and/or displayed to a user can be configured as desired or variable. In one embodiment, a user may interact with map 400 via some form of graphical user interface (GUI) by selecting the displayed technology assets and/or business units representations to obtain more detailed information, such as relationships between the technology assets themselves, the vendor information and evaluative information described above, etc.

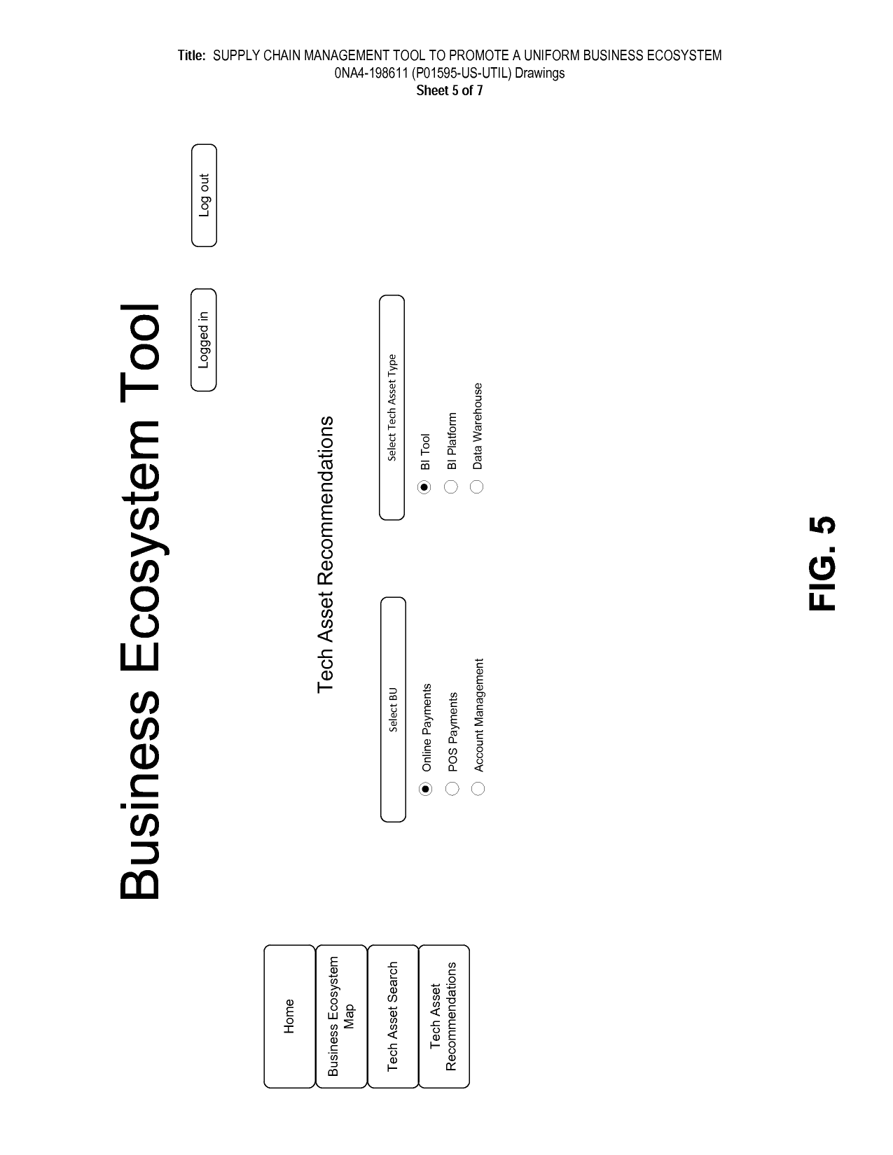

FIG. 5 is an example GUI of a business ecosystem tool in accordance with various embodiments. FIG. 5 illustrates various options a user may select in order to obtain information regarding a company's business ecosystem. For example, a user may select an option to view the company's business ecosystem map, and example of which is map 400. Additionally, a user may obtain a technology asset recommendation. For example, a user may select a business unit of interest, such as an “Online Payments” business unit, a “Point of Sale Payments” business unit, or an “Account Management” business unit of a payment network, e.g., payment network 112. Upon selecting a business unit, the user may select (or alternatively be provided with) options regarding technology asset types, e.g., a business intelligence tool, a business intelligence platform, and a data warehouse. Upon making the appropriate selections, the business ecosystem tool may access the relational database containing information mapping the company's business ecosystem to technology assets, and recommend one or more appropriate vendors that the user can approach, purchase, or otherwise engage in to obtain a desired technology asset. One or more matching, statistical, determinative, or other algorithms can be utilized by the business ecosystem tool in order to make the vendor recommendation. It should be noted that the business ecosystem tool can be a standalone application implemented on a computing device, such as a personal computer, a web-based application accessible by a computing device, and implemented on a server, or other appropriate application for performing various functions as described herein.

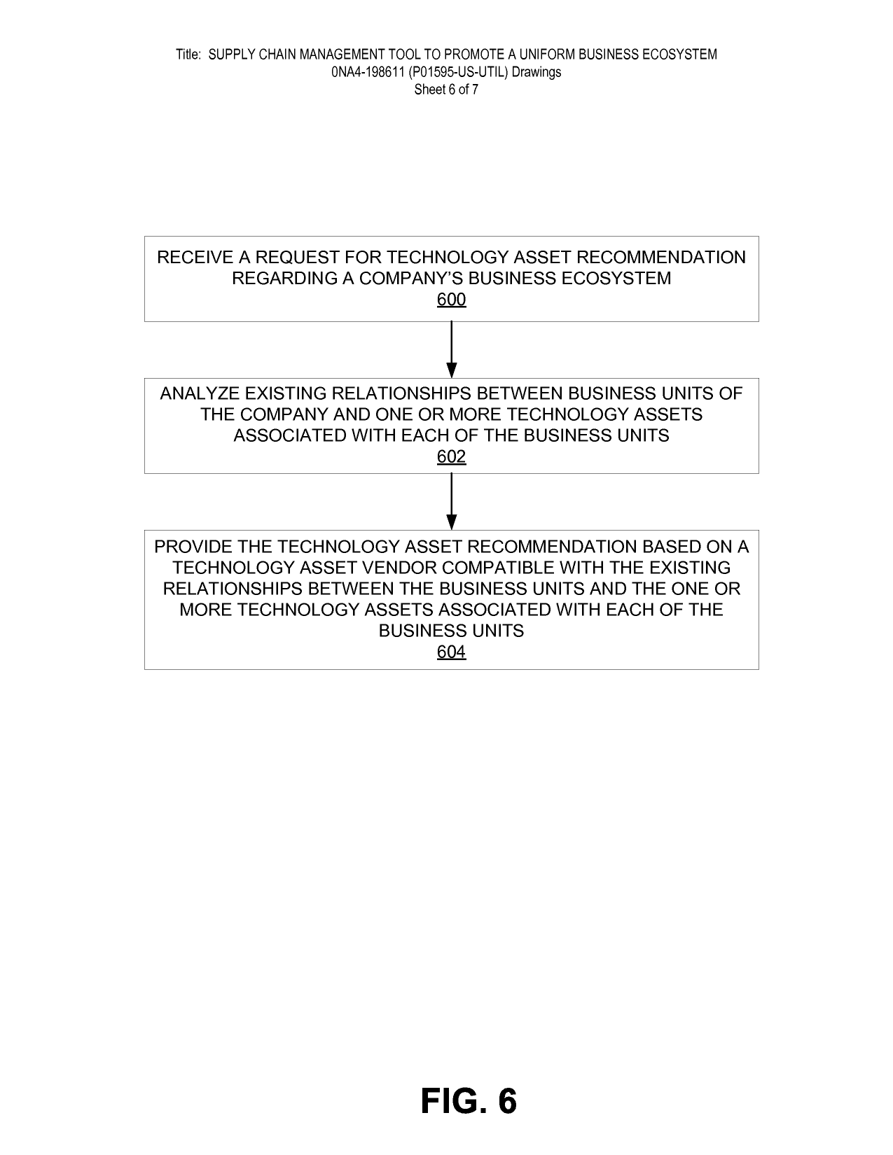

FIG. 6 illustrates example processes performed for providing a technology asset recommendation in accordance with various embodiments. At operation 600, a request for a technology asset recommendation regarding a company's business ecosystem is received. As described above, the business ecosystem tool can include a GUI allowing a supply chain manager or other personnel to inquire as to one or more recommendations regarding a technology asset for implementation in a business ecosystem. For example, a recommendation can be sought for a new data warehouse product, a new business intelligence and/or tool to be implemented thereon, etc. At operation 602, the existing relationships between business units of the company and one or more technology assets associated with each of the business units are analyzed. That is, the business ecosystem tool via one or more relational databases in which various business units and/or functions of a company are mapped to technology assets. The one or more relational databases may further maintain information regarding associated technology asset vendors, interoperability information, rankings, and any other information that may be relevant to determining an optimal or preferred technology asset recommendation that promotes uniformity within the business ecosystem, e.g., ensuring that business intelligence tools are developed using an existing business intelligence platform, thereby avoiding compatibility issues and the like. At operation 604, the technology asset recommendation is provided based on a technology asset vendor compatible with the existing relationships between the business units and the one or more technology assets associated with each of the business units.

Besides promoting a more efficient and uniform business ecosystem, various embodiments allow supply chain management to appropriately react to any changes in the business environment. For example, strategies, future outlooks on business operations, etc. can be developed with knowledge of a business ecosystem components and relationships in conjunction with information associated with, e.g., a particular vendor's financial outlook, product performance compared to other vendors, etc. Any changes to the supply chain can be planned for and implemented more quickly and efficiently, allowing a company to adapt to changing industry conditions, and avoid unwanted discontinuities in its operations.

It should be noted that although various embodiments are described in the context of technology assets, various embodiments can be configured and/or adapted for use with any type or form of a business' resources and/or functions. Moreover, the usefulness of various embodiments can extend beyond a singular business ecosystem, and may applied to, e.g., supply chain management across multiple businesses that deal or interact with other, or otherwise act in cooperation.

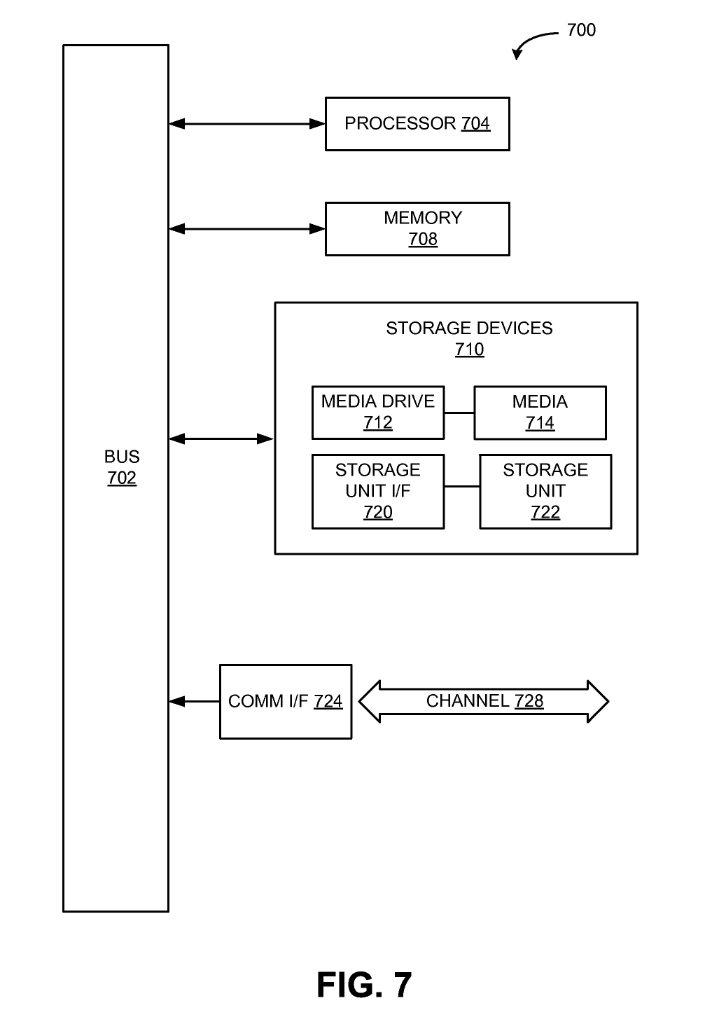

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the application using other computing modules or architectures.

FIG. 7 illustrates an example computing module 700, an example of which may be a processor for executing the business ecosystem tool used to implement various features and/or functionality of the systems and methods disclosed in the present disclosure. Computing module 700 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 700 or to communicate externally.

Computing module 700 might also include one or more memory modules, simply referred to herein as main memory 708. For example, preferably random access memory (RAM) or other dynamic memory might be used for storing information and instructions to be executed by processor 704. Main memory 708 might also be used for storing temporary variables or other intermediate information during execution of instructions to be executed by processor 704. Computing module 700 might likewise include a read only memory (“ROM”) or other static storage device coupled to bus 702 for storing static information and instructions for processor 704.

The computing module 700 might also include one or more various forms of information storage devices 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), or other removable or fixed media drive might be provided. Accordingly, storage media 714 might include, for example, a hard disk, a floppy disk, magnetic tape, cartridge, optical disk, a CD or DVD, or other fixed or removable medium that is read by, written to or accessed by media drive 712. As these examples illustrate, the storage media 714 can include a computer usable storage medium having stored therein computer software or data.

In alternative embodiments, information storage devices 710 might include other similar instrumentalities for allowing computer programs or other instructions or data to be loaded into computing module 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory module) and memory slot, a PCMCIA slot and card, and other fixed or removable storage units 722 and interfaces 720 that allow software and data to be transferred from the storage unit 722 to computing module 700.

Computing module 700 might also include a communications interface 724. Communications interface 724 might be used to allow software and data to be transferred between computing module 700 and external devices. Examples of communications interface 724 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 700 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
receiving a request for a technology asset recommendation regarding a company's business ecosystem;
analyzing existing relationships between business units of the company and one or more technology assets associated with each of the business units; and
providing the technology asset recommendation based on a technology asset vendor compatible with the existing relationships between the business units and the one or more technology assets associated with each of the business units.

2. The method of claim 1, wherein the analysis of the existing relationships comprises accessing a database representative of a mapping of the relationships between the business units and the one or more technology assets associated with each of the business units.

3. The method of claim 2, further comprising displaying a visual representation of the mapping of the relationships between the business units and the one or more technology assets associated with each of the business units.

4. The method of claim 3, further comprising presenting at least one of vendor-related information and evaluative information regarding a vendor associated with each of the one or more technology assets.

5. The method of claim 4, further comprising considering the at least one of the vendor-related information and the evaluative information in addition to the technology asset vendor compatible with the existing relationships when providing the technology asset recommendation.

6. The method of claim 1, wherein the technology asset comprises one of data warehousing technology resource, a business intelligence tool, and a business intelligence platform.

7. The method of claim 1, wherein the technology asset recommendation comprises a to-be-implemented technology asset provided by the technology asset vendor, the technology asset vendor being a provider of at least one already-implemented technology asset.

8. The method of claim 1, wherein the technology asset recommendation comprises a to-be-implemented technology asset having preferred data and software compatibility with at least one already-implemented technology asset.

9. A non-transitory computer-readable medium having computer executable program code embodied thereon, the computer executable program code configured to cause a computer system to:
receive a request for a technology asset recommendation regarding a company's business ecosystem;
access a database representative of a mapping of the relationships between the business units and the one or more technology assets associated with each of the business units; and
provide the technology asset recommendation based on the mapping of the relationships, the technology asset recommendation comprising a compatible technology asset vendor.

10. The non-transitory computer-readable medium of claim 9, wherein the computer executable program code configured to cause the computer system to provide the technology asset recommendation determines compatibility of the technology asset vendor by matching the technology asset vendor to an existing technology asset vendor of the company's business ecosystem.

11. The non-transitory computer-readable medium of claim 9, wherein the computer executable program code configured to further cause the computer system to consider at least one of technology asset vendor-related information and technology asset vendor evaluative information as at least one basis for determining the compatible technology asset vendor.

12. The non-transitory computer-readable medium of claim 9, wherein the technology asset comprises one of a data warehousing technology resource, a business intelligence tool, and a business intelligence platform.

13. The non-transitory computer-readable medium of claim 9, wherein the computer executable program code is configured to further cause the computer system to display a visual representation of the mapping of the relationships between the business units and the one or more technology assets associated with each of the business units.

14. The non-transitory computer-readable medium of claim 13, wherein the computer executable program code is configured to further cause the computer system to present at least one of technology asset vendor-related information and technology asset vendor evaluative information.

15. A supply chain management system, comprising:
a plurality of existing technology assets;
a relational database in which business units are associated with one or more of the plurality of existing technology assets utilized in accomplishing one or more functions of each of the business units; and
a computing device hosting a business ecosystem application configured to access the relational database, and based on the associations, determine a technology asset vendor to provide a to-be-implemented technology asset compatible with at least one of the plurality of existing technology assets.

16. The supply chain management system of claim 15, each of the plurality of existing technology assets and the to-be-implemented technology asset comprises one of a data warehousing technology resource, a business intelligence tool, and a business intelligence platform.

17. The supply chain management system of claim 15, wherein the business ecosystem application is further configured to display a visual representation of the associations between the business units and the plurality of existing technology assets.

18. The supply chain management system of claim 17, wherein the business ecosystem application is further configured to present at least one of technology asset vendor-related information and technology asset vendor evaluative information each of the plurality of existing technology assets.

19. The supply chain management system of claim 15, wherein determining the technology asset vendor to provide the to-be-implemented technology assets comprises determining a technology asset vendor of at least one of the existing technology assets.

20. The supply chain management system of claim 15, wherein the compatibility of the to-be-implemented technology asset with the at least one of the plurality of existing technology assets based upon at least one of data, software, and hardware compatibility.
